(19) United States
(12) Patent Application Publication
(10) Pub. No.: US 2021/0217045 A1
(43) Pub. Date: Jul. 15, 2021

(54) PAYMENT METHOD AND APPARATUS BASED ON MEMBER FEATURE CODE

(71) Applicant: Koubei (Shanghai) Information Technology Co., Ltd., Shanghai (CN)

(72) Inventor: Jianping DAI, Shanghai (CN)

(73) Assignee: Koubei (Shanghai) Information Technology Co., Ltd., Shanghai (CN)

(21) Appl. No.: 17/055,133

(22) PCT Filed: Mar. 7, 2019
(86) PCT No.: PCT/CN2019/077256

§ 371 Date: Nov. 13, 2020

(30) Foreign Application Priority Data
May 14, 2018 (CN) 201810455913.0

(51) Int. Cl. G06Q 30/02; G06Q 20/38

(52) U.S. Cl. CPC G06Q 30/0236; G06Q 20/387; G06Q 20/3821; G06Q 30/0226

(57) ABSTRACT

A payment method based on a member feature code includes: acquiring a member feature code of a store user collected by a store aiming at an order to be paid (S101); identifying a member ID corresponding to the member feature code (S102); generating a discounted order corresponding to the order to be paid according to membership benefits of the member (S103); and paying for the discounted order based on a payment account corresponding to the member ID (S104). During the payment between the store user and the store, the present payment method based on the member feature code helps the store to cultivate the familiarity of the store user with the membership benefits, and meanwhile, enables the payment between the store user and the store to be quicker and more convenient, optimizing the payment experience between the store user and the store.

The present application claims the priority of the Chinese patent application No. 201810455913.0, filed on May 14, 2018 to the China National Intellectual Property Administration (CNIPA) and titled “PAYMENT METHOD AND APPARATUS BASED ON MEMBER FEATURE CODE”, which is incorporated herein by reference in its entirety.

### TECHNICAL FIELD

The present application relates to the field of Internet technology, and in particular to a payment method based on a member feature code. The present application further relates to a payment apparatus based on a member feature code, another payment method and apparatus based on a member feature code, and two electronic devices.

### BACKGROUND

With the continuous development of Internet technology, many Internet-based services have emerged. Taking an offline store as an example, in order to help the offline store with marketing, comprehensive member maintenance and management, as well as business optimization and recommendation, is always provided for the offline store based on store transaction data generated by transactions on an online service platform of the offline store with reference to the rich number of industries on the online service platform.

Currently, a store user of the offline store needs to use membership card accumulating points or enjoy membership benefits (e.g., members of the offline store) during the payment. The regular payment process is as follows: the store user first activates an e-wallet, enters a card package of the e-wallet, selects a membership card to be used from the card package, and shows a bar code or QR code of the membership card; a cashier in the store uses a POS system to scan the bar code or QR code of the membership card to identify the current paying member, and further generates a store order based on the identified member information; and at the same time, the store user shows a payment code, and the store cashier uses the POS system again to scan the payment code shown by the store user to complete operation of the current store order.

It thus can be seen that in the prior art, in the case that a member of an offline store pays in his/her member code or membership benefits, it is necessary to first scan the member code of the member, and then scan the payment code shown by the member. The store member needs to show the member code and the payment code at twice during the payment, and the offline store needs to scan twice, resulting in a cumbersome and complicated payment process.

### SUMMARY

The present application provides a payment method based on a member feature code to overcome the shortcomings in the prior art. The present application further relates to a payment apparatus based on a member feature code, another payment method and apparatus based on a member feature code, and two electronic devices.

The present application provides a payment method based on a member feature code, including:

acquiring a member feature code of a store user collected by a store aiming at an order to be paid;

identifying a member ID corresponding to the member feature code;

generating a discounted order corresponding to the order to be paid according to membership benefits of the member ID; and

paying for the discounted order based on a payment account corresponding to the member ID.

Optionally, after paying for the discounted order based on the payment account corresponding to the member ID, the payment method further includes:

transmitting an order payment result acquired after paying for the discounted order to a payment terminal.

Optionally, before acquiring the member feature code of the store user collected by the store aiming at the order to be paid, the payment method further includes:

receiving a registration request of the store user for a registered member of the store transmitted by the payment terminal;

registering the store user as a new member of the store and allocating a corresponding member ID to the store user; and

establishing a corresponding relation between the member ID of the store user and a payment account.

Optionally, after generating the discounted order corresponding to the order to be paid according to the membership benefits of the member ID and before paying for the discounted order based on the payment account corresponding to the member ID, the payment method further includes:

checking whether the member ID acquires a withholding authorization for the payment account of the store user, and if yes, according to the withholding authorization, executing the step of paying for the discounted order based on the payment account corresponding to the member ID.

Optionally, if an execution result of the step of checking whether the member ID acquires the withholding authorization for the payment account of the store user is NO, the payment method includes:

transmitting an application request for applying to the payment account for the withholding authorization for the member ID to the payment terminal, receiving an authorization message from the payment terminal that the withholding authorization has been activated, and executing the step of paying for the discounted order based on the payment account corresponding to the member ID.

Optionally, paying for the discounted order based on the payment account corresponding to the member ID includes:

debiting the payment account corresponding to the member ID based on the withholding authorization; and

paying for an account to be credited of the store to which the discounted order belongs according to an amount of debiting the payment account corresponding to the member ID to acquire the order payment result.

Optionally, after paying for the discounted order based on the payment account corresponding to the member ID, and before transmitting the order payment result acquired after paying for the discounted order to the payment terminal, the payment method includes:

calculating member points accumulated after the payment for the discounted order is completed according to the order payment result; and

updating membership benefits of the member ID according to the member points.

Correspondingly, the order payment result transmitted to the payment terminal includes updated membership benefits of the member ID.

Optionally, the member feature code means an image identification code of the store user. Correspondingly, the member feature code is collected by an image collecting apparatus configured for the store and is uploaded by a store terminal configured for the store.

The present application further provides a payment apparatus based on a member feature code, including:

a member feature code acquiring unit, configured to acquire a member feature code of a store user collected by a store aiming at an order to be paid;

a member ID identifying unit, configured to identify a member ID corresponding to the member feature code;

a discounted-order generating unit, configured to generate a discounted order corresponding to the order to be paid according to membership benefits of the member ID; and

an order paying unit, configured to pay for the discounted order based on a payment account corresponding to the member ID.

The present application further provides another payment method based on a member feature code, including:

receiving a show instruction for a member feature code entered by a store user;

showing the member feature code of the store user according to the show instruction; and

showing membership benefits of a member ID corresponding to the store user in an order payment result transmitted by a server.

The order payment result is acquired by paying for a discounted order corresponding to an order to be paid of a store according to a payment account corresponding to the membership benefits of the member ID corresponding to the member feature code.

Optionally, after showing the member feature code of the store user according to the show instruction and before showing the membership benefits of the member ID corresponding to the store user in the order payment result transmitted by the server, the payment method includes:

receiving the order payment result transmitted by the server.

Optionally, before receiving the show instruction for the member feature code entered by the store user, the payment method includes:

receiving a registration request for a registered member for the store entered by the store user; and

transmitting the registration request to the server.

Optionally, before receiving the order payment result transmitted by the server, the payment method includes:

receiving an application request, transmitted by the server, for applying to the payment account for a withholding authorization for the member ID;

activating the withholding authorization for the member ID in the payment account based on the application request; and

transmitting an authorization message that the withholding authorization has been activated to the server.

Optionally, the member feature code means an image identification code of the store user; and correspondingly, after the step of s hawing the member feature code of the store user according to the show instruction and before the step of receiving the order payment result transmitted by the server, the member feature code is collected by an image collecting apparatus configured for the store and is uploaded by a store terminal configured for the store.

The present application further provides another payment apparatus based on a member feature code, including:

a show instruction receiving unit, configured to receive a show instruction for a member feature code entered by a store user;

a member feature code showing unit, configured to show the member feature code of the store user according to the show instruction; and

a membership benefits showing unit, configured to show membership benefits of a member ID corresponding to the store user in an order payment result transmitted by a server.

The order payment result is acquired by paying for a discounted order corresponding to an order to be paid of a store according to a payment account corresponding to the membership benefits of the member ID corresponding to the member feature code.

The present application further provides an electronic device, including:

a memory and a processor.

The memory is configured to store a computer-executable instruction, and the processor is configured to execute the following computer-executable instructions:

acquiring a member feature code of a store user collected by a store aiming at an order to be paid;

identifying a member ID corresponding to the member feature code;

generating a discounted order corresponding to the order to be paid according to membership benefits of the member ID; and

paying for the discounted order based on a payment account corresponding to the member ID.

The present application further provides another electronic device, including:

a memory and a processor.

The memory is configured to store a computer-executable instruction, and the processor is configured to execute the following computer-executable instructions:

receiving a show instruction for a member feature code entered by a store user;

showing the member feature code of the store user according to the show instruction; and

showing membership benefits of a member ID corresponding to the store user in an order payment result transmitted by a server.

The order payment result is acquired by paying for a discounted order corresponding to an order to be paid of a store according to a payment account corresponding to the membership benefits of the member ID corresponding to the member feature code.

The payment method based on the member feature code provided by the present application includes: acquiring a member feature code of a store user collected by a store aiming at an order to be paid; identifying a member ID corresponding to the member feature code; generating a discounted order corresponding to the order to be paid according to membership benefits of the member ID; and paying for the discounted order based on a payment account corresponding to the member ID.

During the payment between the store user and the store, the present payment method based on the member feature code pays for the discounted order on the premise that the store user enjoys the membership benefits based on the member feature code of the store user collected by the store according to the membership benefits of the member ID identified in the member feature code, helps the store to cultivate the familiarity of the store user with the membership benefits, and meanwhile, enables the payment between the store user and the store to be quicker and more convenient, optimizing the payment experience between the store user and the store.

### BRIEF DESCRIPTION OF THE DRAWINGS

FIG. 1 is a processing flow diagram of a payment method based on a member feature code in accordance with an embodiment of the present application;

FIG. 2 is a schematic diagram of a payment scene based on a member feature code in accordance with the present application;

FIG. 3 is a schematic diagram of a payment apparatus based on a member feature code in accordance with an embodiment of the present application;

FIG. 4 is a processing flow diagram of another payment method based on a member feature code in accordance with an embodiment of the present application;

FIG. 5 is a schematic diagram of another payment apparatus based on a member feature code in accordance with an embodiment of the present application;

FIG. 6 is a schematic diagram of an electronic device in accordance with the present application; and

FIG. 7 is a schematic diagram of another electronic device in accordance with the present application.

### DETAILED DESCRIPTION

Many specific details will be explained in the following description in order to fully understand the present application. However, the present application can be implemented in many other ways different from those described herein, and those skilled in the art can make similar promotion without violating the connotation of the present application. Therefore, the present application is not limited by the specific embodiments disclosed below.

The present application provides a payment method based on a member feature code, and further provides a payment apparatus based on a member feature code, another payment method and apparatus based on a member feature code, and two electronic devices, which will be described one by one in detail with reference to the drawings attached to the embodiments provided by the present application, and each step of the method will also be explained.

An embodiment of a payment method based on a member feature code in accordance with the present application is described as below.

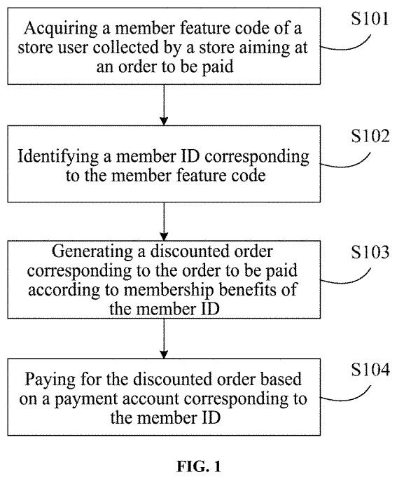

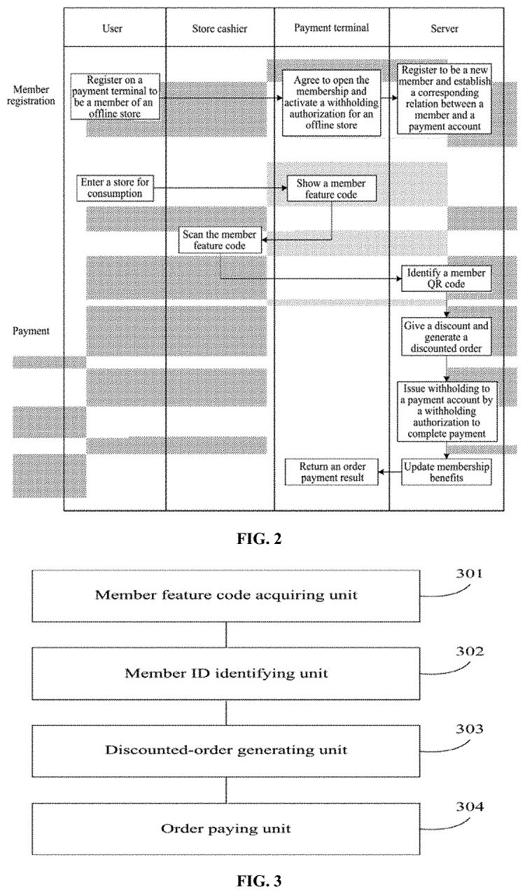

Refer to FIG. 1, which is a processing flow diagram of a payment method based on a member feature code in accordance with an embodiment of the present application. Refer to FIG. 2, which is a schematic diagram of a payment scene based on a member feature code in accordance with the present application.

In step S101, a member feature code of a store user collected by a store aiming at an order to be paid is acquired.

Currently, life service applications are widely used by users. With life service recommendations, the users can learn about basic information, service evaluations, store environment evaluations, etc. of various life-related stores, and can also use the life service applications to make payments. Especially for offline stores in such industries having offline physical stores as restaurants, hotels, games, entertainment, beauty, massage, sports and fitness which are characterized by more frequent consumption, improving users' consumption and service experience in the stores has become the key to store revenue. For store users (i.e., store members) who have become offline store members, how to improve the payment experience of the store members in the offline stores during the payment is particularly important. Similarly, for the offline stores, how to improve the convenience in payment has become a top priority.

The payment method based on the member feature code provided by the present embodiment is implemented based on a server, and a payment method based on a member feature code provided by the following method embodiment is implemented based on a payment terminal. In practice, the two methods are used together for implementing payments in the offline stores based on the member feature code. In particular, during payment of a store user in an offline store, the two actions of showing a member code and a payment code by the store user in the offline store are integrated, and the cashier' two actions of scanning the member code and the payment code shown by the store user in the offline store are also combined, such that only one time of showing by the store member and one time of scanning by the offline store are required to implement the payment, enabling the payment between the store member and the offline store to be quicker and more convenient and optimizing the payment experience between the store member and the offline store.

The member feature code described in the present embodiment means an image identification code of the store member of the offline store, i.e., the member code of the store member in the current store, e.g., a QR code or bar code generated after transcoding according to the member information of the store member.

In the present embodiment, when making a payment in the offline store, the store member shows his/her own member feature code to the cashier of the offline store; at the sight of the member feature code shown by the store member, the cashier collects the member feature code, shown by the store member, using an image collecting apparatus (e.g., a code scanning terminal) configured for the offline store; after the store collects the member feature code of the store member by the store, it uploads the collected member feature code to the server; and the server performs payment processing according to the uploaded member feature code, as shown in FIG. 2. In this step, the server acquires the member feature code of the store member collected by the offline store aiming at the order to be paid.

It should be noted that the store user makes the payment through the member code in the offline store on the following premise: the store user has already registered to be a member of the offline store and has become a store member of the offline store. Based on this, the payment is made in the offline store according to the member feature code of the store user. In a preferred embodiment provided by the present application, before acquiring the member feature code of the store member collected by the offline store aiming at the order to be paid, the following member registration operation needs to be performed: receiving a registration request, transmitted by the payment terminal, of the store user for a registered member of the offline store, and registering the store user who initiates the registration request as a new member of the offline store; i.e., registering the store user who initiates the registration request as a store member of the offline store, allocating a corresponding member ID to the store user, and establishing a corresponding relation between a member ID of the store user and a payment account.

In step S102, a member ID corresponding to the member feature code is identified.

In the above step S101, the member feature code of the store member collected by the offline store aiming at the order to be paid is acquired. In this step, the member ID corresponding to the member feature code is identified. For example, a QR code or bar code of the store member of an offline store is transcoded after being acquired to acquire the member ID of the store member, as shown in FIG. 2.

In step S103, a discounted order corresponding to the order to be paid is generated according to membership benefits of the member ID.

During payment for the order to be paid that is generated by the store member consuming in the current offline store after the member ID of the store member is identified in the above step, the order to be paid that is generated by the store member consuming in the current offline store needs to be discounted according to membership benefits that the store member can enjoy in the current offline store, such that the discounted order corresponding to the order to be paid is acquired. The discounted order shall be understood as an order obtained after the store member gets a discount in the offline store according to his/her own membership benefits.

In specific implementation, after the corresponding discounted order is generated by discounting the order to be paid that is generated by the store member consuming in the current offline store according to the membership benefits that the store member can enjoy in the offline store, and before paying for the discounted order, it is also necessary to check whether the store user activates a withholding authorization for the current offline store. In a preferred embodiment provided by the present application, in particular, whether the store user activates the withholding authorization for the current offline store is checked by checking whether the member ID of the store member acquires a withholding authorization for a payment account of the store member. If yes, it indicates that the store member has already activated the withholding authorization for the current offline store. At this time, the next step S104 is executed to pay for the discounted order based on the activation of the withholding authorization. If no, it indicates that the store member has not yet activated the withholding authorization for the current offline store, and preferably, the store member activates the withholding authorization for the current offline store by the following way.

An application request of applying to the current offline store for the withholding authorization for the store member is transmitted to the payment terminal in the payment account of the store member, the payment terminal activates, based on the application request and in the payment account, the withholding authorization for the store member in the current store after receiving the application request, and transmits an authorization message that the withholding authorization has been activated to the server; and the server executes the following step S104 of paying for the discounted order based on the fact that the withholding authorization is activated.

It thus can be seen that by activating the withholding authorization for the payment account of the store member in the offline store, the payment can be made directly based on the payment account of the store member after the discounted order is generated. Therefore, a payment action of the store member is eliminated to optimize the experience of the store member, and a collection action of the offline store is eliminated to enable the payment process of the offline store to be more convenient and quicker.

In step S104, the discounted order is paid based on a payment account corresponding to the member ID.

In specific implementation, this step is to pay for the discounted order based on the payment account of the store member, which is preferably implemented in the following way: debiting the payment account of the store member based on the withholding authorization activated by the payment account of the store member in the current offline store; paying for an account to be credited of the offline store to which the discounted order belongs using an amount of debiting the payment account of the store member; and acquiring the order payment result after the payment is completed.

In a preferred embodiment provided by the present application, after the payment for the discounted order is completed based on the payment account of the store member, member points accumulated after the payment for the discounted order is completed, i.e., member points that the store member may accumulate for the current order (the discounted order) in the offline store, are further calculated based on the order payment result obtained by the payment. The membership benefits of the store member are updated according to the member points accumulated after the payment for the discounted order is completed. For example, if the membership benefits of the store member in the offline store are embodied as total member points, the total member points of the store member are updated according to the member points; or, if the membership benefits of the store member in the offline store are embodied as membership levels, the membership level of the store member is updated according to the member points.

In practice, in this step, the order payment result obtained after paying for the discounted order may be transmitted to the payment terminal after the discounted order is paid based on the payment account of the store member. In particular, the order payment result obtained after paying for the discounted order is transmitted to the payment terminal to notify the payment terminal that the payment for the current discounted order has been completed.

As stated above, the membership benefits of the store member are updated after the payment for the discounted order is completed based on the payment account of the store member. Therefore, when the order payment result is transmitted to the payment terminal, the updated membership benefits of the store member should also be transmitted to the payment terminal. In particular, the membership benefits of the store member are added to the order payment result to be transmitted to the payment terminal, and a transmitting terminal reads the updated membership benefits of the store member in the order payment result after receiving the order payment result. Thus, changes of the membership benefits of the store member may be shown to the store member in time; and meanwhile, the offline store may be assisted in cultivating the familiarity of the store member with the membership benefits.

In summary, during the payment between the store member and the offline store, the payment method based on the member feature code provided by the embodiment of the present application pays for the discounted order on the premise that the store member enjoys the membership benefits based on the member feature code of the store member collected by the offline store according to the membership benefits of the member ID identified in the member feature code, returns the order payment result to the payment terminal, helps the offline store to cultivate the familiarity of the store member with the membership benefits, and meanwhile, enables the payment between the store member and the offline store to be quicker and more convenient, optimizing the payment experience between the store member and the offline store.

An embodiment of a payment method based on a member feature code in accordance with the present application is described as below.

In the foregoing embodiment, a payment method based on a member feature code is provided. Correspondingly, the present application provides a payment apparatus based on a member feature code, which will be described with reference to the drawings.

Refer to FIG. 3, which is a schematic diagram of an embodiment of a payment apparatus based on a member feature code in accordance with the present application.

The apparatus embodiment is basically similar to the method embodiment and thus is relatively simple in description. For its related portions, please refer to corresponding descriptions of the method embodiment provided above. The apparatus embodiments described below are merely illustrative.

The present application provides a payment apparatus based on a member feature code, including:

a member feature code acquiring unit 301, configured to acquire a member feature code of a store user collected by a store aiming at an order to be paid;

a member ID identifying unit 302, configured to identify a member ID corresponding to the member feature code;

a discounted-order generating unit 303, configured to generate a discounted order corresponding to the order to be paid according to membership benefits of the member ID; and

an order paying unit 304, configured to pay for the discounted order based on a payment account corresponding to the member ID.

Optionally, the payment apparatus based on the member feature code includes:

an order payment result transmitting unit, configured to transmit an order payment result acquired by paying for the discounted order to a payment terminal.

Optionally, the payment apparatus based on the member feature code includes:

a registration request receiving unit, configured to receive a registration request of the store user for a registered member of the store transmitted by the payment terminal;

a new-member registering unit, configured to register the store user as a new member of the store and allocate a corresponding member ID to the store user; and

a corresponding-relation establishing unit, configured to establish a corresponding relation between the member ID of the store user and a payment account.

Optionally, the payment apparatus based on the member feature code includes:

a withholding authorization checking unit, configured to check whether the member ID acquires a withholding authorization for a payment account of the store user, and if yes, operate the order paying unit 304 based on the withholding authorization.

Optionally, if a check result output by the order paying unit 304 is NO, a withholding authorization activating unit is operated. The withholding authorization activating unit is configured to transmit an application request for applying to the payment account for the withholding authorization for the member ID to the payment terminal, to receive an authorization message that the withholding authorization has been activated from the payment terminal, and to operate the order paying unit 304.

Optionally, the order paying unit 304 includes:

a withholding sub-unit, configured to debit the payment account corresponding to the member ID based on the withholding authorization; and

a payment sub-unit, configured to pay for an account to be credited of the store to which the discounted order belongs according to an amount of debiting the payment account corresponding to the member ID to acquire the order payment result.

Optionally, the payment apparatus based on the member feature code includes:

a member points calculating unit, configured to calculate member points accumulated after the payment for the discounted order is completed according to the order payment result; and

a membership benefits updating unit, configured to update membership benefits of the member ID according to the member points.

Correspondingly, the order payment result transmitted to the payment terminal includes updated membership benefits of the member ID.

Optionally, the member feature code means an image identification code of the store user. Correspondingly, the member feature code is collected by an image collecting apparatus configured for the store and is uploaded by a store terminal configured for the store.

An embodiment of another payment method based on a member feature code in accordance with the present application is described as below.

In the foregoing embodiment, the payment method based on the member feature code is provided. In addition, the present application provides another payment apparatus based on a member feature code, which matches the payment method based on the member feature code in the foregoing embodiment. The payment method based on the member feature code provided by the foregoing embodiment is implemented based on a server. The payment method based on the member feature code provided by the present embodiment is implemented based on a payment terminal that matches the server. The present embodiment is relatively simple in description, and a reference may be made to corresponding descriptions of the payment method based on the member feature code in the foregoing embodiment for reading of the present embodiment.

Refer to FIG. 2, which is a schematic diagram of a payment scene based on a member feature code in accordance with the present application. Refer to FIG. 4, which is a processing flow diagram of an embodiment of another payment method based on a member feature code in accordance with the present application.

In step S401, a show instruction for a member feature code entered by a store user is received.

During payment of a store member in an offline store, the two actions of showing a member code and a payment code by the store member in the offline store are integrated, and correspondingly, the offline store' two actions of scanning the member code and the payment code shown by the store member are also combined, such that only one time of showing by the store member and one time of scanning by the offline store are required to implement the payment, enabling the payment between the store member and the offline store to be quicker and more convenient and optimizing the payment experience between the store member and the offline store.

In practice, showing the member feature code by the payment terminal to the cashier of the offline store is inevitably initiated by the store user corresponding to the payment terminal (e.g., a user who has a mobile terminal running the payment terminal). Here, in this step, the payment terminal receives the show instruction entered by the store user for showing the member feature code.

In specific implementation, if a store user currently engaged in consumption activities in the offline store has not yet registered as a member of the offline store, the store user may register to be a member of the offline store by the following preferred implementation for member registration provided by the present embodiment. In particular, the payment terminal receives a registration request for member registration entered by the store user for the offline store, and transmits the registration request to the server; and after receiving the registration request transmitted by the payment terminal, the server may register the store user who initiates the registration request as a new member of the offline store, i.e., register the store user who initiates the registration request as a store member of the offline store, allocate the corresponding member ID to the store member, and establish a corresponding relation between the member ID of the store member and a payment account.

In step S402, the member feature code of the store user is shown according to the show instruction.

The member feature code described in the present embodiment means an image identification code of the store member of the offline store, i.e., the member code of the store member in the current store, e.g., a QR code or bar code generated after transcoding according to the member information of the store member.

In step S403, membership benefits of a member ID corresponding to the store user in an order payment result transmitted by a server are shown.

In specific implementation, when making a payment in the offline store, the store member shows his/her own member feature code to the cashier of the offline store; at the sight of the member feature code shown by the store member, the cashier collects the member feature code, shown by the store member, using an image collecting apparatus (e.g., a code scanning terminal) configured for the offline store; after the store collects the member feature code of the store member by the store, it uploads the collected member feature code to the server; and after receiving the member feature code of the store member, the server identifies the member ID corresponding to the member feature code first, then discounts the order to be paid that is generated by the store member consuming in the current offline store according to the membership benefits that the store member can enjoy in the current offline store to acquire the discounted order corresponding to the order to be paid, pays for the discounted order based on the payment account of the store member, and finally, transmits the order payment result to the payment terminal. Here, the payment terminal receives the order payment result transmitted by the server, as shown in FIG. 2.

As stated above, during the payment, the server needs to check whether the store member has activated a withholding authorization for the current offline store. If the store member has not yet activated the withholding authorization for the current offline store, the withholding authorization of the store member for the current offline store needs to be activated. In this process, if the payment terminal receives an application request, transmitted by the server, for applying to the payment account of the store member for a withholding authorization in the current offline store, the payment terminal activates the withholding authorization for the payment account of the store member in the current offline store based on the application request and transmits an authorization message that the withholding authorization has been activated to the server after activation of the withholding authorization is completed.

The payment terminal receives the order payment result transmitted by the server. Here, the membership benefits of the member ID corresponding to the store user are read from the order payment result and shown to the user, so that the user is able to perceive changes of his/her own membership benefits in time.

An embodiment of another payment apparatus based on a member feature code in accordance with the present application is described as below.

In the foregoing embodiment, another payment method based on a member feature code is provided. Correspondingly, the present application further provides another payment apparatus based on a member feature code, which will be described below with reference to the drawings.

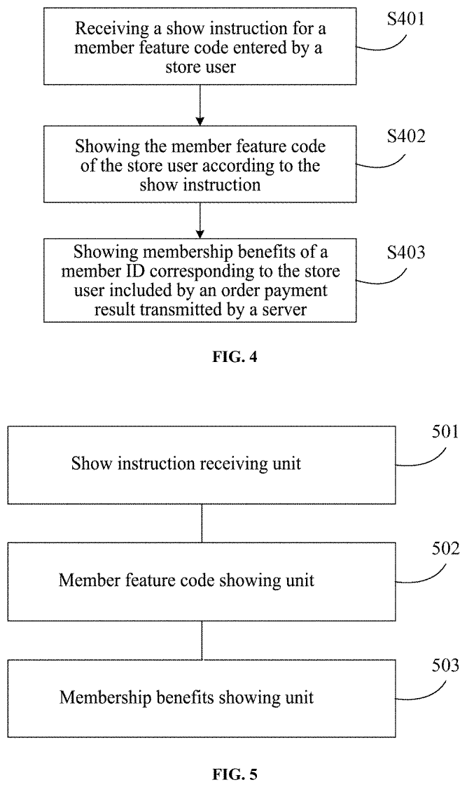

Refer to FIG. 5, which is a schematic diagram of another payment apparatus based on a member feature code in accordance with the present application.

The apparatus embodiment is basically similar to the method embodiment, and thus is relatively simple in description. For its relevant portions, please refer to corresponding descriptions of the above-described embodiment of the another payment method based on the member feature code. The apparatus embodiments described below are merely illustrative.

The present application provides a payment apparatus based on a member feature code, including:

a show instruction receiving unit 501, configured to receive a show instruction for a member feature code entered by a store user;

a member feature code showing unit 502, configured to show the member feature code of the store user according to the show instruction; and

a membership benefit showing unit 503, configured to show membership benefits of a member ID corresponding to the store user in an order payment result transmitted by a server.

The order payment result is acquired by paying for a discounted order corresponding to an order to be paid of a store according to a payment account corresponding to the membership benefits of the member ID corresponding to the member feature code,

Optionally, the payment apparatus based on the member feature code includes:

an order payment result receiving unit, configured to receive the order payment result transmitted by the server.

Optionally, the payment apparatus based on the member feature code includes:

a registration request receiving unit, configured to receive a registration request for a registered member for the store entered by the store user; and

a registration request transmitting unit, configured to transmit the registration request to the server.

Optionally, the payment apparatus based on the member feature code includes:

an application request receiving unit, configured to receive an application request, transmitted by the server, for applying to the payment account for a withholding authorization for the member ID;

a withholding authorization activating unit, configured to activate the withholding authorization for the member ID in the payment account based on the application request; and

an authorization message transmitting unit, configured to transmit an authorization message that the withholding authorization has been activated to the server.

Optionally, the member feature code means an image identification code of the store user. Correspondingly, after the member feature code showing unit 502 works and before the order payment result receiving unit works, the member feature code is collected by an image collecting apparatus configured for the store and is uploaded by a store terminal configured for the store.

An embodiment of an electronic device provided by the present application is described as below.

In the foregoing embodiment, a payment method based on a member feature code is provided. In addition, the present application further provides an electronic device for implementing the payment method based on the member feature code, which will be described in detail with reference to drawings.

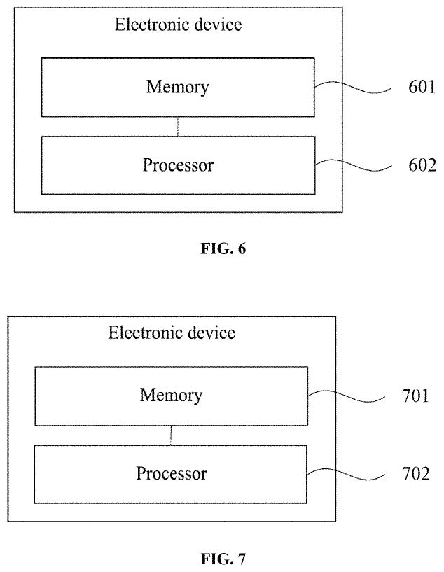

Refer to FIG. 6, which is a schematic diagram of an electronic device in accordance with an embodiment.

The electronic device embodiment provided by the present application is relatively simple in description, and for its relevant portions, please refer to corresponding descriptions of the above-described embodiment of the payment method based on the member feature code. The embodiments described below are merely illustrative.

The present application provides an electronic device, including:

a memory 601 and a processor 602.

The memory 601 is configured to store computer-executable instructions, and the processor 602 is configured to execute the following computer-executable instructions:

acquiring a member feature code of a store user collected by a store aiming at an order to be paid;

identifying a member ID corresponding to the member feature code;

generating a discounted order corresponding to the order to be paid according to membership benefits of the member ID; and

paying for the discounted order based on a payment account corresponding to the member ID.

Optionally, after executing the instruction of paying for the discounted order based on the payment account corresponding to the member ID, the processor 602 is further configured to execute the following computer-executable instruction:

transmitting an order payment result acquired after paying for the discounted order to a payment terminal.

Optionally, before executing the instruction of acquiring the member feature code of the store user collected by the store aiming at the order to be paid, the processor 602 is further configured to execute the computer-executable instructions:

receiving a registration request of the store user for a registered member of the store transmitted by the payment terminal;

registering the store user as a new member of the store and allocating a corresponding member ID to the store user; and

establishing a corresponding relation between the member ID of the store user and a payment account.

Optionally, after executing the instruction of generating, according to the membership benefits of the member ID, the discounted order corresponding to the order to be paid and before executing the instruction of paying for the discounted order based on the payment account corresponding to the member ID, the processor 602 is further configured to execute the following computer-executable instruction:

checking whether the member ID acquires a withholding authorization for a payment account of the store user, and if yes, according to the withholding authorization, executing the step of paying for the discounted order based on the payment account corresponding to the member ID.

Optionally, if an execution result of the step of checking whether the member ID acquires the withholding authorization for the payment account of the store user is NO, the processor 602 is further configured to execute the following computer-executable instruction:

transmitting an application request for applying to the payment account for the withholding authorization for the member ID to the payment terminal, receiving an authorization message from the payment terminal that the withholding authorization has been activated, and executing the step of paying for the discounted order based on the payment account corresponding to the member ID.

Optionally, paying for the discounted order based on the payment account corresponding to the member ID includes:

debiting the payment account corresponding to the member ID based on the withholding authorization; and

paying for an account to be credited of the store to which the discounted order belongs according to an amount of debiting the payment account corresponding to the member ID to acquire the order payment result.

Optionally, after executing the instruction of paying for the discounted order based on the payment account corresponding to the member ID, and before executing the instruction of transmitting the order payment result acquired after paying for the discounted order to the payment terminal, the processor 602 is further configured to execute the following computer-executable instructions:

calculating member points accumulated after the payment for the discounted order is completed according to the order payment result; and

updating membership benefits of the member ID according to the member points.

Correspondingly, the order payment result transmitted to the payment terminal includes updated membership benefits of the member ID.

Optionally, the member feature code means an image identification code of the store user. Correspondingly, the member feature code is collected by an image collecting apparatus configured for the store and is uploaded by a store terminal configured for the store.

An embodiment of another electronic device provided by the present application is described as below.

In the foregoing embodiment, another payment method based on a member feature code is provided. In addition, the present application further provides another electronic device for implementing the payment method based on the member feature code, which will be described in detail with reference to drawings.

Refer to FIG. 7, which is a schematic diagram of another electronic device in accordance with the present application.

The electronic device embodiment provided by the present application is relatively simple in description, and for its relevant portions, please refer to corresponding descriptions of the method embodiment provided above. The embodiments described below are merely illustrative.

The present application provides an electronic device, including:

a memory 701 and a processor 702.

The memory 701 is configured to store computer-executable instructions, and the processor 702 is configured to execute the following computer-executable instructions:

receiving a show instruction for a member feature code entered by a store user;

showing the member feature code of the store user according to the show instruction; and

showing membership benefits of a member ID corresponding to the store user in an order payment result transmitted by a server.

The order payment result is acquired by paying for a discounted order corresponding to an order to be paid of a store according to a payment account corresponding to the membership benefits of the member ID corresponding to the member feature code.

Optionally, after executing the instruction of showing the member feature code of the store user according to the show instruction and before executing the instruction of showing the membership benefits of the member ID corresponding to the store user in the order payment result transmitted by the server, the processor 702 is further configured to execute the following computer-executable instruction:

receiving the order payment result transmitted by the server.

Optionally, before executing the instruction of receiving the show instruction for the member feature code entered by the store user, the processor 702 is further configured to execute the following computer-executable instructions:

receiving a registration request for a registered member for the store entered by the store user; and

transmitting the registration request to the server.

Optionally, before executing the instruction of receiving the order payment result transmitted by the server, the processor 702 is further configured to execute the following computer-executable instructions:

receiving an application request, transmitted by the server, for applying to the payment account for a withholding authorization for the member ID;

activating the withholding authorization for the member ID in the payment account based on the application request; and

transmitting an authorization message that the withholding authorization has been activated to the server.

Optionally, the member feature code means an image identification code of the store user. Correspondingly, after the step of showing the member feature code of the store user according to the show instruction and before the step of receiving the order payment result transmitted by the server, the member feature code is collected by an image collecting apparatus configured for the store and is uploaded by a store terminal configured for the store.

Although the present application is disclosed as above in preferred embodiments, these preferred embodiments are not intended to limit the present application. Any person skilled in the art can make possible changes and modifications without departing from the spirit and scope of the present application. Therefore, the protection scope of the present application should be subjected to the scope defined by the Claims of the present application.

In a typical configuration, a computing device includes one or more processors (CPUs), input/output interfaces, network interfaces, and memories.

The memory may include a computer readable medium in the form of a non-persistent memory, a random-access memory (RAM), and/or a non-volatile memory, such as a read only memory (ROM) or a flash random-access memory (flash RAM). The memory is an example of the computer readable medium.

The computer readable medium includes both persistent and non-persistent and removable and non-removable media that may be implemented in any method or technology for storage of information. The information may be computer readable instructions, data structures, program modules or other data. Examples of the computer storage medium include, but are not limited to, a phase-change RAM (PRAM), a static random-access memory (SRAM), a dynamic random-access memory (DRAM), other types of random-access memory (RAM), a read-only memory (ROM), an electrically erasable programmable read-only memory (EEPROM), a flash memory or other memory technologies, compact disk read-only memory (CD-ROM), a digital versatile disk (DVD) or other optical storage, magnetic cassettes, a magnetic tape, a magnetic disk storage or other magnetic storage devices, or any other non-transmission media that can be used to store information for access by a computing device. As defined herein, the computer readable medium excludes transitory computer readable media, such as modulated data signals and carrier waves.

It should be appreciated by those skilled in the art that, the embodiments of the present application may be provided as methods, systems or computer program products. Therefore, the present application may adopt embodiments in forms of hardware only, software only, or a combination of software and hardware. Furthermore, the present application may adopt forms of computer program products executed on one or more computer usable storage media (including but not limited to a disk storage, a CD-ROM, an optical storage, etc.) containing computer usable program codes.

1. A payment method based on a member feature code, comprising:
obtaining, by a server, a member feature code of a store user collected by a store aiming at an order to be paid, wherein a member identification corresponds to the member feature code;
identifying, by the server, the member identification based on the member feature code, wherein the member identification corresponding to a member membership benefit;
generating, by the server, a discounted order corresponding to the order to be paid according to the membership benefit of the member identification; and
making payment, by the server, for the discounted order based on a payment account corresponding to the member identification.

2. The payment method based on the member feature code according to claim 1, wherein after making payment for the discounted order based on a payment account corresponding to the member identification, the payment method further comprises:
transmitting an order payment result acquired after paying for the discounted order to a payment terminal.

3. The payment method based on the member feature code according to claim 2, wherein before obtaining the member feature code of the store user collected by the store aiming at the order to be paid, the payment method further comprises:
receiving a registration request of the store user for a registered member of the store transmitted by the payment terminal;
registering the store user as a new member of the store and allocating a corresponding member identification to the store user; and
establishing a corresponding relation between the member identification of the store user and a payment account.

4. The payment method based on the member feature code according to claim 3, wherein after generating the discounted order corresponding to the order to be paid according to the membership benefit of the member identification and before making payment for the discounted order based on a payment account corresponding to the member identification, the payment method further comprises:
checking whether the member identification acquires a withholding authorization for a payment account of the store user, and if yes, according to the withholding authorization, executing the step of paying for the discounted order based on the payment account corresponding to the member identification.

5. The payment method based on a member feature code according to claim 4, wherein if an execution result of the step of checking whether the member identification acquires the withholding authorization for the payment account of the store user is NO, the payment method comprises:
transmitting an application request for applying to the payment account for the withholding authorization for the member identification to the payment terminal, receiving an authorization message from the payment terminal that the withholding authorization has been activated, and executing the step of making payment for the discounted order based on a payment account corresponding to the member identification.

6. The payment method based on the member feature code according to claim 5, wherein making payment for the discounted order based on a payment account corresponding to the member identification comprises:
debiting the payment account corresponding to the member identification based on the withholding authorization; and
paying for an account to be credited of the store to which the discounted order belongs according to an amount of debiting the payment account corresponding to the member identification to acquire the order payment result.

7. The payment method based on the member feature code according to claim 6, wherein after making payment for the discounted order based on a payment account corresponding to the member identification, and before transmitting the order payment result acquired after paying for the discounted order to the payment terminal, the payment method comprises:
calculating member points accumulated after the payment for the discounted order is completed according to the order payment result; and
updating membership benefits of the member identification according to the member points, wherein
correspondingly, the order payment result transmitted to the payment terminal comprises updated membership benefits of the member identification.

8. The payment method based on the member feature code according to claim 1, wherein the member feature code means an image identification code of the store user, and correspondingly, the member feature code is collected by an image collecting apparatus configured for the store and is uploaded by a store terminal configured for the store.

9. (canceled)

10. A payment method based on the member feature code, comprising:
receiving, by a payment terminal, a show instruction for a member feature code entered by a store user;
showing, by the payment terminal, the member feature code of the store user according to the show instruction; and
showing, by the payment terminal, membership benefits of a member identification corresponding to the store user in an order payment result transmitted by a server, wherein
the order payment result is acquired by paying for a discounted order corresponding to an order to be paid of a store according to a payment account corresponding to the membership benefits of the member identification corresponding to the member feature code.

11. The payment method based on a member feature code according to claim 10, wherein after showing the member feature code of the store user according to the show instruction and before showing the membership benefits of the member identification corresponding to the store user in the order payment result transmitted by the server, the payment method comprises:
receiving the order payment result transmitted by the server.

12. The payment method based on a member feature code according to claim 11, wherein before receiving the show instruction for the member feature code entered by the store user, the payment method comprises:
receiving a registration request for a registered member for the store entered by the store user; and
transmitting the registration request to the server.

13. The payment method based on a member feature code according to claim 12, wherein before receiving the order payment result transmitted by the server, the payment method comprises:
receiving an application request, transmitted by the server, for applying to the payment account for a withholding authorization for the member identification;
activating the withholding authorization for the member identification in the payment account based on the application request; and
transmitting an authorization message that the withholding authorization has been activated to the server.

14. The payment method based on the member feature code according to claim 10, wherein the member feature code means an image identification code of the store user, and correspondingly, after the step of showing the member feature code of the store user according to the show instruction and before the step of receiving the order payment result transmitted by the server, the member feature code is collected by an image collecting apparatus configured for the store and is uploaded by a store terminal configured for the store.

15. (canceled)

16. An electronic device, comprising:
a memory and a processor, wherein
the memory is configured to store a computer-executable instruction, and the processor is configured to execute the following computer-executable instructions:
obtaining a member feature code of a store user collected by a store aiming at an order to be paid, wherein a member identification corresponds to the member feature code;
identifying the member identification based on the member feature code, wherein the member identification corresponding to a member membership benefit;
generating a discounted order corresponding to the order to be paid according to the membership benefit of the member identification; and
making payment, by the server, for the discounted order based on a payment account corresponding to the member identification.

17. (canceled)
